(19) United States
(12) Patent Application Publication
(10) Pub. No.: US 2009/0325569 A1
(43) Pub. Date: Dec. 31, 2009

(54) SYSTEM AND METHOD FOR DEVICE-ASSISTED MEASUREMENT OF NEIGHBORING WIRELESS ENVIRONMENT

(75) Inventor: Chie-Ming CHOU, Cingshuei Township (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Industrial Technology Research Institute

(21) Appl. No.: 12/255,983

(22) Filed: Oct. 22, 2008

Related U.S. Application Data
(60) Provisional application No. 61/075,444, filed on Jun. 25, 2008.

(51) Int. Cl. H04W 4/00; H04M 1/00

(52) U.S. Cl. 455/422.1; 455/561

(57) ABSTRACT

A method for a serving wireless network to collect information regarding a neighboring wireless network. The method includes requesting a device to collect information regarding the neighboring wireless network; and receiving the collected information from the device.

### RELATED APPLICATIONS

This application is based upon and claims the benefit of priority from U.S. Provisional Patent Application No. 61/075,444, filed Jun. 25, 2008, the entire contents of which are incorporated herein by reference.

### FIELD OF THE INVENTION

This invention relates to systems and methods for device-assisted measurement of a neighboring wireless environment.

### BACKGROUND OF THE INVENTION

In conventional wireless cellular networks, a cell planning method is typically needed to decide system operation parameters, such as operating frequencies, transmission power, etc. Due to a possibly complex neighboring wireless environment, an operator of a serving wireless network may employ engineers to determine a suitable cell plan for the serving wireless network by practical testing.

For example, the neighboring wireless environment may include neighboring wireless networks that are close to the serving wireless network, and operation of the neighboring wireless networks may affect operation of the serving wireless network. The engineers may perform measurement of, e.g., strength of signals transmitted from the neighboring wireless networks, to determine a suitable cell plan for the serving wireless network.

To save cost for such cell planning, self-organization and optimization methods may be applied to the serving wireless network for measurement of the neighboring wireless environment. For example, based on the self-organization and optimization methods, a network side, such as a base station in the serving wireless network, may be configured to perform the measurement. However, the neighboring wireless environment may include neighboring wireless networks unknown to the serving wireless network, and the serving wireless network may not coordinate with the unknown neighboring wireless networks before performing the measurement. As a result, the measurement may be performed under a condition of uncertain carrier frequencies and uncertain operation timing of the unknown neighboring wireless networks. To perform such measurement, the base station in the serving wireless network may need to temporarily stop current services to or communications with its subscribing devices, which may waste time and degrade performance of the serving wireless network.

Also for example, based on the self-organization and optimization methods, a device side such as a mobile station may be required to perform the measurement of the neighboring wireless environment. The network side, e.g., the base station, may trigger the device side, e.g., the mobile station, to perform the measurement. The device side then reports results of the measurement to the network side. The network side further makes a decision for the cell planning based on the reported results. However, the results of the measurement may not accurately reflect a real condition of the neighboring wireless environment. Therefore, the network side may make an incorrect decision with regard to the cell planning.

FIG. 1 illustrates a conventional method 100 for a mobile station (MS) communicating with a base station (BS) to request entry into an idle mode, according to IEEE standard 802.16. When there is no on-demand transmission of communication data, the MS may enter the idle mode. For example, the MS may send a deregistration request (DREG-REQ) message to the BS when the MS wants to enter the idle mode (step 102). After receiving the DREQ-REQ message, the BS may respond by sending a deregistration command (DREG-CMD) message to the MS, indicating actions that the MS needs to take after entering the idle mode (step 104). The MS may then enter the idle mode.

When in the idle mode, the MS may be in an unavailable period or an available period. In the unavailable period, the MS disconnects with the BS. For example, the MS may turn off its power to save battery power. In the available period, the MS performs network re-entry to receive a broadcast message from the BS (step 106).

### SUMMARY OF THE INVENTION

In accordance with the invention, there is provided a method for a serving wireless network to collect information regarding a neighboring wireless network, the method comprising: requesting a device to collect information regarding the neighboring wireless network; and receiving the collected information from the device.

Also in accordance with the invention, there is provided a base station in a serving wireless network, the base station being configured to: request a device to collect information regarding a neighboring wireless network of the serving wireless network; and receive the collected information from the device.

Further in accordance with the invention, there is provided a method for a device to collect for a serving wireless network information regarding a neighboring wireless network of the serving wireless network, the method comprising: receiving, from the serving wireless network, a request to collect the information; collecting the information based on the request; and reporting the collected information to the serving wireless network.

Further in accordance with the invention, there is provided a device to collect for a serving wireless network information regarding a neighboring wireless network, the device being configured to: receive, from the serving wireless network, a request to collect the information; collect the information based on the request; and report the collected information to the serving wireless network.

Further in accordance with the invention, there is provided a method for a serving wireless network to perform measurement of a neighboring wireless network, the method comprising: collecting information regarding the neighboring wireless network; and performing the measurement based on the collected information.

Further in accordance with the invention, there is provided a base station in a serving wireless network, the base station being configured to: collect information regarding a neighboring wireless network of the serving wireless network; and perform measurement of the neighboring wireless network based on the collected information.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and, together with the description, serve to explain the principles of the invention.

FIG. 1 illustrates a conventional method for a mobile station (MS) communicating with a base station (BS) to request entry into an idle mode, according to IEEE standard 802.16.

FIG. 2 illustrates a method for a mobile station in a serving wireless network to collect information regarding unknown neighboring wireless networks, according to an exemplary embodiment.

FIG. 3A illustrates a serving wireless network and a neighboring wireless network, and FIG. 3B illustrates a method for a serving base station in the serving wireless network to measure signals transmitted by a neighboring base station in the neighboring wireless network, according to an exemplary embodiment.

FIG. 4A illustrates a serving wireless network and a neighboring wireless network, and FIG. 4B illustrates a method for a serving base station in the serving wireless network to measure signals transmitted by a neighboring base station in the neighboring wireless network, according to an exemplary embodiment.

FIG. 5 illustrates a block diagram of an exemplary base station (BS), according to an exemplary embodiment.

FIG. 6 illustrates a block diagram of an exemplary mobile station (MS), according to an exemplary embodiment.

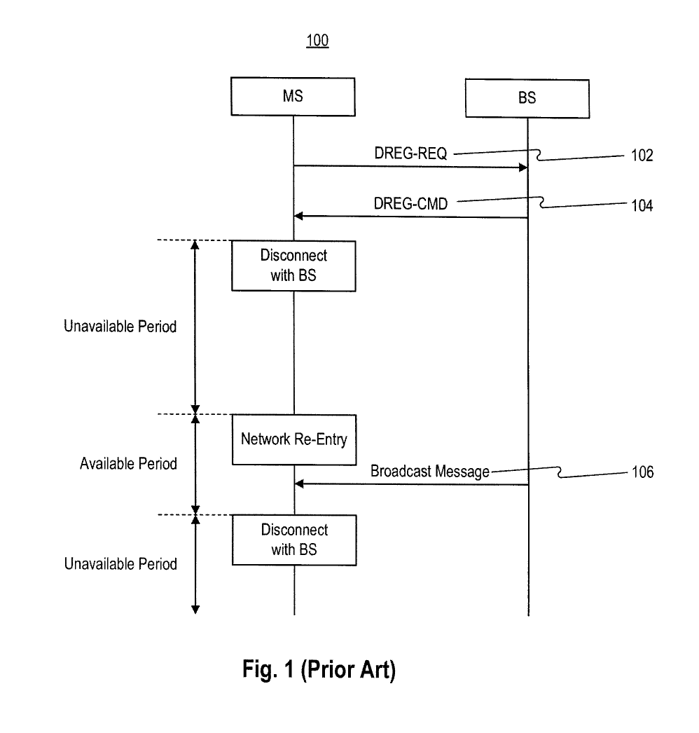

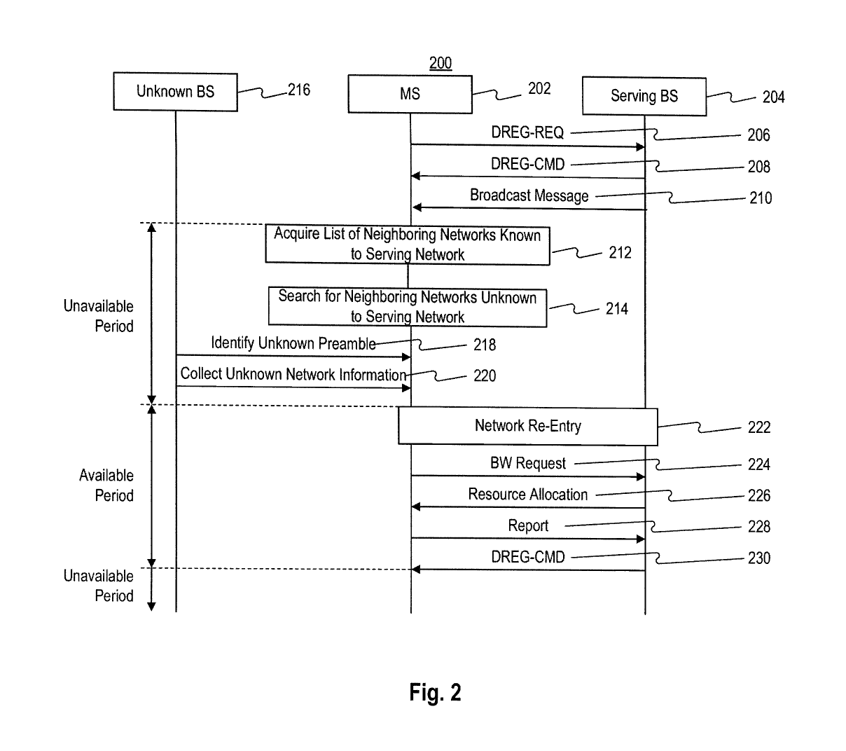

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention as recited in the appended claims.

In exemplary embodiments consistent with the present invention, there is provided a method for a serving wireless network to perform measurement of a neighboring wireless environment. For example, the serving wireless network may request a device, such as a user terminal or a mobile station in the serving wireless network, to collect information, e.g., operation timing, regarding neighboring wireless networks unknown to the serving wireless network, and receive the collected information from the device. In addition, the serving wireless network may acquire information, e.g., operation timing, regarding neighboring wireless networks known to the serving wireless network through a network backbone. The serving wireless network further performs measurement of, e.g., strength of signals transmitted from the known or unknown neighboring wireless networks, based on the information. In other words, the serving wireless network may measure the known or unknown neighboring wireless networks by measuring the signals transmitted from the known or unknown neighboring wireless networks.

In exemplary embodiments consistent with the present invention, the device may collect the information regarding the unknown neighboring wireless networks when the device is in an idle mode. For example, when there is no on-demand transmission of communication data, the device may enter the idle mode. The serving wireless network may request the device to collect the information regarding the unknown neighboring wireless networks when the device is in the idle mode. For illustrative purposes only, it is assumed the serving wireless network is based on the IEEE standard 802.16.

FIG. 2 illustrates a method 200 for a mobile station (MS) 202 in the serving wireless network to collect information regarding unknown neighboring wireless networks, according to an exemplary embodiment. The MS 202 sends a deregistration request (DREG-REQ) message to a serving base station (BS) 204 in the serving wireless network when the MS 202 wants to enter the idle mode (206). In response, the serving BS 204 sends a deregistration command (DREG-CMD) message to the MS 202 (208). The DREG-CMD message may include an indicator that requests the MS 202 to collect information regarding the unknown neighboring wireless networks when the MS 202 is in the idle mode. For example, the DREG-CMD message may include an action code indicating that the MS 202 is requested to collect information, e.g., operation timing, regarding the unknown neighboring wireless networks when in the idle mode.

In accordance with the action code, the MS 202 does not disconnect from the serving BS 204 immediately after receiving the DREG-CMD message. Instead, the MS 202 may disconnect from the serving BS 204 when the MS 202 receives a broadcast message (210). The MS 202 then enters the idle mode. When in the idle mode, the MS 202 may be in an unavailable period or an available period.

In the unavailable period, the MS 202 may decode the broadcast message received from the serving BS 204 to thereby acquire a list of neighboring wireless networks known to the serving wireless network (212). For example, the list may include operating frequencies of the known neighboring wireless networks. The MS 202 may store the operating frequencies of the known neighboring wireless networks in its database.

The MS 202 then searches for neighboring wireless networks that are not known to the serving wireless network (214). For example, the MS 202 may perform this search by scanning frequencies that are not included in the acquired list. If the MS 202 does not identify a synchronization signal or a preamble signal at a current scanned frequency, the MS 202 may try to identify a synchronization signal or a preamble signal at a next scanned frequency. When the MS 202 identifies a synchronization signal or a preamble signal from an unknown BS, e.g., an unknown BS 216, in an unknown neighboring wireless network at a scanned frequency (218), the MS 202 may try to receive a broadcast message from the unknown BS 216. After receiving the broadcast message from the unknown BS 216, the MS 202 may collect further information regarding that unknown neighboring wireless network (220). For example, the MS 202 may record operation timing of the unknown BS 216 based on the broadcast message received from the unknown BS 216.

In the available period, the MS 202 performs network re-entry to establish connection with the serving BS 204 (222). In other words, the MS 202 re-establishes connection with the serving BS 204. The MS 202 further sends a bandwidth (BW) request to the serving BS 204 (224), the requested bandwidth being used to transmit to the serving BS 204 collected information regarding the unknown neighboring wireless network, such as operating frequencies and/or operation timing of the unknown BS 216.

Upon receiving the bandwidth request, the serving BS 204 allocates uplink resources for the MS 202 (226). The MS 202 may then use the allocated uplink resources to send a report including the collected information regarding the unknown neighboring wireless network to the serving BS 204 (228). After receiving the report, the serving BS 204 may send a next DREG-CMD message to the MS 202 (230).

The next DREG-CMD message may include an action code indicating that the MS 202 is requested to restart the idle mode. For example, in accordance with the action code, the MS 202 may continue to collect information regarding the unknown neighboring wireless networks, similar to the process described above.

As a result, the serving BS 204 may receive from one or more mobile stations in the serving wireless network information regarding the unknown neighboring wireless networks. In addition, the serving BS 204 may acquire information regarding known neighboring wireless networks, such as operating frequencies and operation timings of BSs in the known neighboring wireless networks, through a network backbone. The serving wireless network further performs measurement of, e.g., strength of signals transmitted from the known or unknown neighboring wireless networks, collectively referred to hereafter as neighboring wireless networks, as more fully explained below.

In exemplary embodiments consistent with the present invention, the serving BS 204 may compare operation timing of a neighboring BS in one of the neighboring wireless networks with its own operation timing in a comparing stage, based on the collected or acquired information regarding the neighboring wireless networks. The serving BS 204 may further receive and measure signals transmitted by the neighboring BS in a measuring stage.

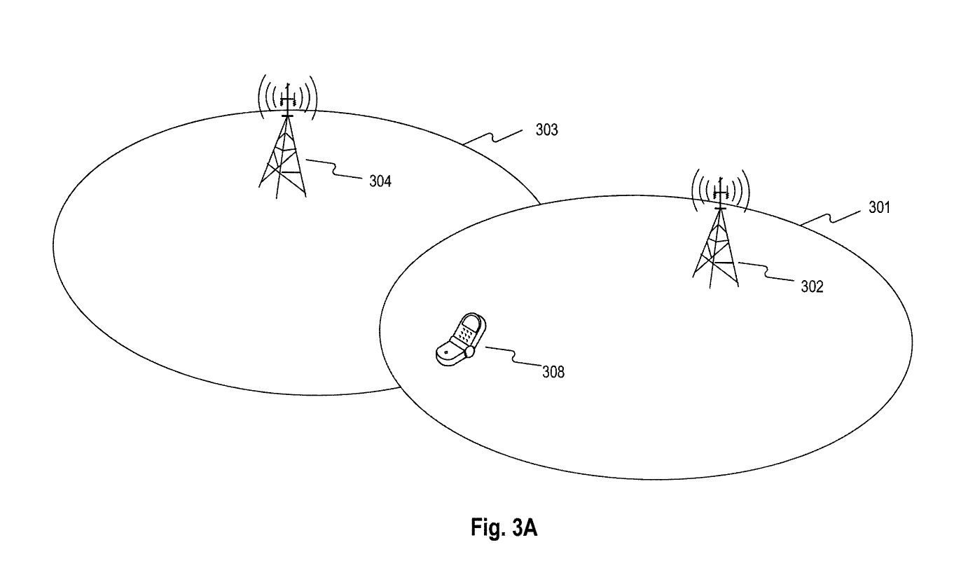

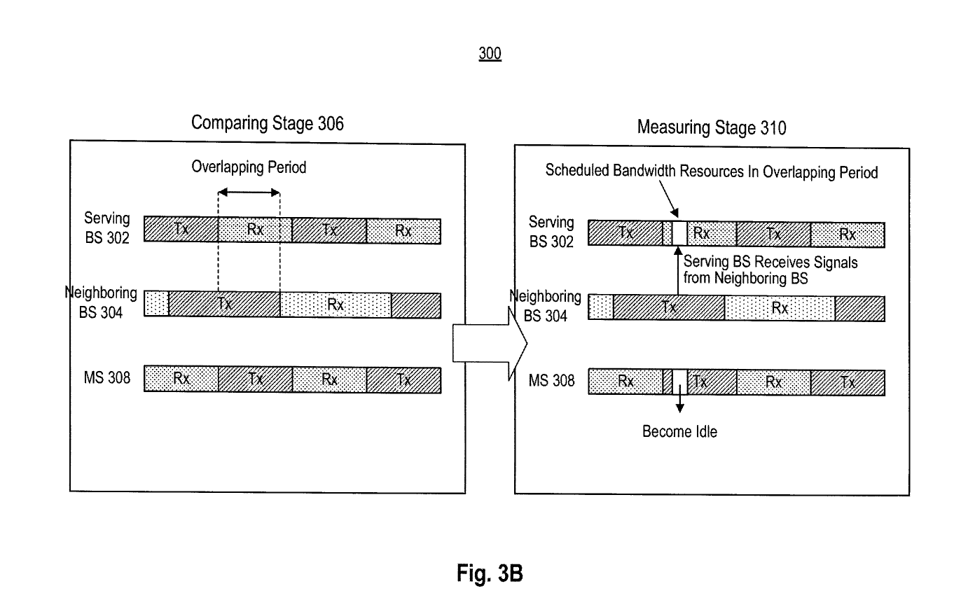

FIG. 3A illustrates a serving wireless network 301 including a serving BS 302, and a neighboring wireless network 303 including a neighboring BS 304. An MS 308 is located within the serving wireless network 301 and is served by the serving BS 302. FIG. 3B illustrates a method 300 for the serving BS 302 to measure signals transmitted by the neighboring BS 304, according to an exemplary embodiment. Referring to FIGS. 3A and 3B, the serving BS 302 compares operation timing of the neighboring BS 304 with its own operation timing in a comparing stage 306. For example, as shown in FIG. 3B, the serving BS 302 may determine there is an overlapping period between a transmitting cycle (Tx) for the neighboring BS 304 and a receiving cycle (Rx) for the serving BS 302 based on the comparison. The serving BS 302 may then schedule bandwidth resources for a predetermined period in the receiving cycle, during the overlapping period, to receive signals transmitted by the neighboring BS 304. The serving BS 302 further sends a message to each MS in the serving wireless network 301, e.g., the MS 308, notifying each MS in the serving wireless network 301 to be idle during the predetermined period. In a measuring stage 310, the serving BS 302 receives signals transmitted by the neighboring BS 304 during the predetermined period, and performs measurement. For example, the serving BS 302 may measure link quality of communication between the serving BS 302 and the neighboring BS 304 based on, e.g., strength of the received signals. Each MS in the serving wireless network 301 remains idle during the predetermined period.

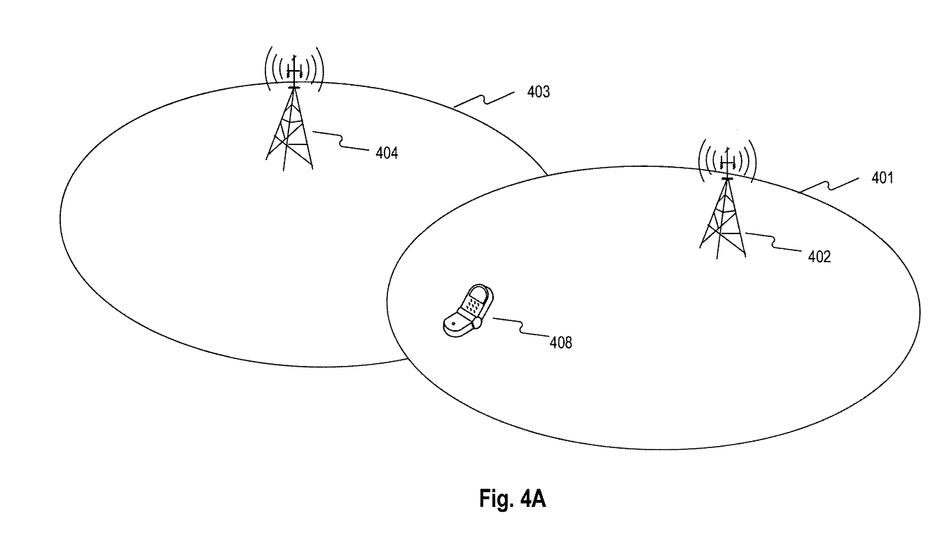

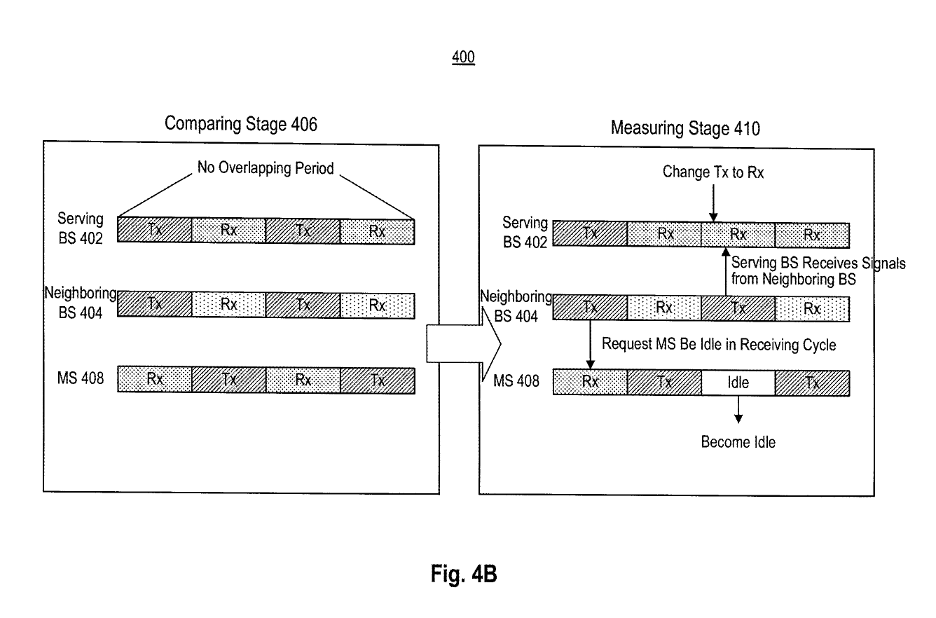

FIG. 4A illustrates a serving wireless network 401 including a serving BS 402, and a neighboring wireless network 403 including a neighboring BS 404. An MS 408 is located within the serving wireless network 401 and is served by the serving BS 402. FIG. 4B illustrates a method 400 for the serving BS 402 to measure signals transmitted by the neighboring BS 404, according to an exemplary embodiment. Referring to FIGS. 4A and 4B, the serving BS 402 compares operation timing of the neighboring BS 404 with its own operation timing in a comparing stage 406. For example, as shown in FIG. 4B, the operation timing of the neighboring BS 404 may be in synchronism with the operation timing of the serving BS 402. As a result, the serving BS 402 may determine there is no overlapping period between a transmitting cycle (Tx) of the neighboring BS 404 and a receiving cycle (Rx) of the serving BS 402 based on the comparison. The serving BS 402 may replace a predetermined transmitting cycle of the serving BS 402 with a replacement receiving cycle. The serving BS 402 also sends a message to each MS in the serving wireless network 401, e.g., the MS 408, to notify each MS in the serving wireless network 401 to be idle for receiving its data during a receiving cycle corresponding to the replacement receiving cycle of the serving BS 402. Accordingly, in the replacement receiving cycle, the serving BS 402 may allocate bandwidth resources to receive signals transmitted by the neighboring BS 404. As a result, in a measuring stage 410, the serving BS 402 receives signals transmitted by the neighboring BS 404 in the replacement receiving cycle, and performs measurement. For example, the serving BS 302 may measure link quality of communication between the serving BS 302 and the neighboring BS 304 based on, e.g., strength of the received signals. Each MS in the serving wireless network 401 remains idle during its receiving cycle that corresponds to the replacement receiving cycle of the serving BS 402.

In exemplary embodiments consistent with the present invention, specific wireless devices, other than mobile stations in the serving wireless network, may be deployed in the serving wireless network to collect information regarding the unknown neighboring wireless networks. Typically, the specific wireless devices may not perform services other than collecting the information regarding the unknown neighboring wireless networks. For example, the specific wireless devices may collect the information and send a report including the collected information to the serving BS according to 222-228 in FIG. 2. As a result, the operator of the serving wireless network does not need to be concerned about, e.g., security problems, when measurement of signals transmitted from the unknown neighboring wireless networks is performed, and cost of the measurement may be reduced.

In exemplary embodiments consistent with the present invention, a serving wireless network and a neighboring wireless network may be based on different radio access technologies (RATs). For example, the serving wireless network may be a network based on the IEEE 802.16m standard, while the neighboring wireless network may be a network based on a non-IEEE 802.16m standard. An MS in the serving wireless network may operate in a multiple-RAT mode, and be requested by the serving wireless network to collect information regarding the neighboring wireless network. For example, the MS may enter the neighboring wireless network, and collect information regarding the neighboring wireless network, based on a synchronization signal and/or a broadcast message received from the neighboring wireless network. The MS further sends a report including the collected information to a serving BS in the serving wireless network. Based on the report, the serving BS may configure its operation timing to include a suitable period for receiving signals from the neighboring wireless network, and measure the received signals, as described above.

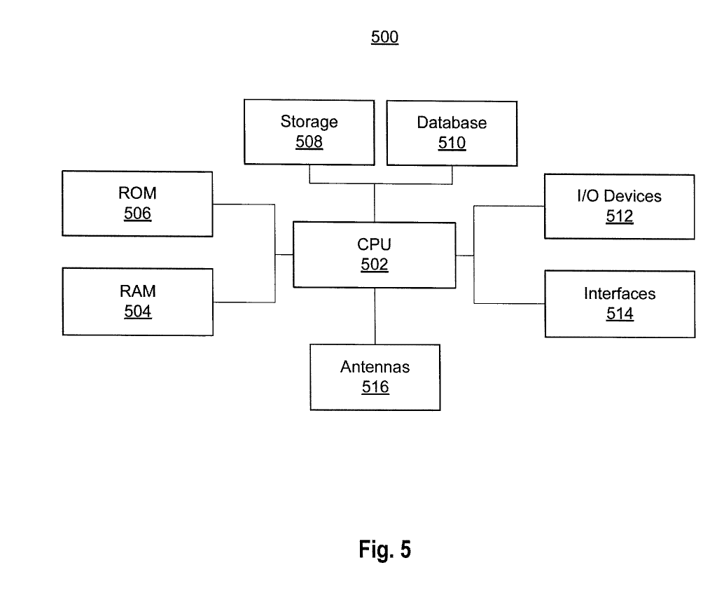

FIG. 5 illustrates a block diagram of an exemplary base station (BS) 500, according to an exemplary embodiment. For example, the BS 500 may be the serving BS 302 (FIG. 3A) or the serving BS 402 (FIG. 4A). Referring to FIG. 5, the BS 500 may include one or more of the following components: at least one central processing unit (CPU) 502 configured to execute computer program instructions to perform various processes and methods, random access memory (RAM) 504 and read only memory (ROM) 506 configured to access and store information and computer program instructions, storage 508 to store data and information, databases 510 to store tables, lists, or other data structures, I/O devices 512, interfaces 514, antennas 516, etc. Each of these components is well-known in the art and will not be discussed further.

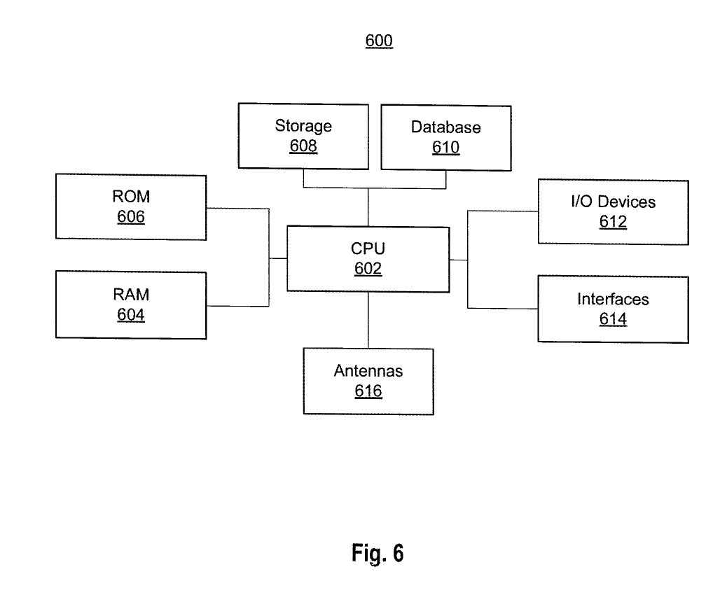

FIG. 6 illustrates a block diagram of an exemplary mobile station (MS) 600, according to an exemplary embodiment. For example, the MS 600 may be the MS 308 (FIG. 3A) or the MS 408 (FIG. 4A). Referring to FIG. 6, the MS 600 may include one or more of the following components: at least one central processing unit (CPU) 602 configured to execute computer program instructions to perform various processes and methods, random access memory (RAM) 604 and read only memory (ROM) 606 configured to access and store information and computer program instructions, storage 608 to store data and information, databases 610 to store tables, lists, or other data structures, I/O devices 612, interfaces 614, antennas 616, etc. Each of these components is well-known in the art and will not be discussed further.

Other embodiments of the invention will be apparent to those skilled in the art from consideration of the specification and practice of the invention disclosed here. The scope of the invention is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for a serving wireless network to collect information regarding a neighboring wireless network, the method comprising:
requesting a device to collect information regarding the neighboring wireless network; and
receiving the collected information from the device.

2. The method of claim 1, wherein the requesting comprises requesting a user terminal in the serving wireless network to collect information regarding the neighboring wireless network.

3. The method of claim 2, further comprising:
sending to the user terminal a list of neighboring wireless networks known to the serving wireless network; and
receiving, from the user terminal, information regarding a neighboring wireless network unknown to the serving wireless network, the unknown neighboring wireless network not being included in the list.

4. The method of claim 3, wherein the receiving comprises receiving information regarding operation timing of a base station in the unknown neighboring wireless network.

5. The method of claim 3, wherein the receiving comprises receiving information regarding an operating frequency of a base station in the unknown neighboring wireless network.

6. A base station in a serving wireless network, the base station being configured to:
request a device to collect information regarding a neighboring wireless network of the serving wireless network; and
receive the collected information from the device.

7. A method for a device to collect for a serving wireless network information regarding a neighboring wireless network of the serving wireless network, the method comprising:
receiving, from the serving wireless network, a request to collect the information;
collecting the information based on the request; and
reporting the collected information to the serving wireless network.

8. The method of claim 7, wherein the receiving further comprises:
sending, by the device, a deregistration request message to a serving base station in the serving wireless network when the device wants to enter an idle mode.

9. The method of claim 8, wherein the receiving further comprises:
receiving a deregistration command message from the serving base station, the deregistration command message including an indicator that requests the device to collect the information.

10. The method of claim 9, wherein the receiving further comprises:
receiving a broadcast message from the serving base station; and
decoding the received broadcast message to acquire a list of neighboring wireless networks known to the serving wireless network.

11. The method of claim 7, wherein the collecting further comprises:
searching for a neighboring wireless network that is not known to the serving wireless network.

12. The method of claim 11, wherein the searching further comprises:
identifying a synchronization signal from an unknown base station in the neighboring wireless network that is not known to the serving wireless network.

13. The method of claim 12, wherein the collecting further comprises:
receiving a broadcast message from the unknown base station; and
collecting the information based on the received broadcast message.

14. The method of claim 7, wherein the reporting further comprises:
re-establishing connection with a serving base station in the serving wireless network.

15. The method of claim 14, wherein the reporting further comprises:
reporting the collected information to the serving base station.

16. The method of claim 7, wherein the receiving further comprises receiving a list of neighboring wireless networks known to the serving wireless network.

17. The method of claim 16, wherein the collecting further comprises collecting information regarding a neighboring wireless network unknown to the serving wireless network, the unknown neighboring wireless network not being included in the list.

18. The method of claim 7, wherein the collecting further comprises collecting information regarding an operating frequency of a base station in the neighboring wireless network.

19. The method of claim 7, wherein the collecting further comprises collecting information regarding operation timing of a base station in the neighboring wireless network.

20. The method of claim 7, wherein the device communicates with the serving wireless network and the neighboring wireless network based on different radio access technologies (RATs).

21. A device to collect for a serving wireless network information regarding a neighboring wireless network, the device being configured to:
receive, from the serving wireless network, a request to collect the information;
collect the information based on the request; and
report the collected information to the serving wireless network.

22. The device of claim 21, wherein the device is a mobile station in the serving wireless network.

23. A method for a serving wireless network to perform measurement of a neighboring wireless network, the method comprising:
collecting information regarding the neighboring wireless network; and
performing the measurement based on the collected information.

24. The method of claim 23, wherein the neighboring wireless network is unknown to the serving wireless network, the collecting comprising:
requesting a user terminal to collect the information regarding the neighboring wireless network.

25. The method of claim 23, wherein the neighboring wireless network is known to the serving wireless network, the collecting comprising:
acquiring the information regarding the neighboring wireless network through a network backbone.

26. The method of claim 23, wherein the collecting comprises collecting information regarding an operating frequency of a base station in the neighboring wireless network.

27. The method of claim 23, wherein the collecting comprises collecting information regarding operation timing of a base station in the neighboring wireless network.

28. The method of claim 23, wherein the performing comprises:
determining whether there is an overlapping period between a receiving cycle for a first base station in the serving wireless network and a transmitting cycle for a second base station in the neighboring wireless network.

29. The method of claim 28, wherein when it is determined that there is an overlapping period between a receiving cycle for the first base station and a transmitting cycle for the second base station, the performing further comprises:
receiving, in the overlapping period, signals from the second base station; and
measuring link quality of communication between the first and second base stations based on the received signals.

30. The method of claim 28, wherein when it is determined that there is no overlapping period between a receiving cycle for the first base station and a transmitting cycle for the second base station, the performing further comprises:
replacing an original transmitting cycle of the first base station with a replacement receiving cycle;
receiving, in the replacement receiving cycle, signals from the second base station; and
measuring link quality of communication between the first and second base stations based on the received signals.

31. The method of claim 30, further comprising notifying user terminals in the serving wireless network be idle for receiving in a period corresponding to the replacement receiving cycle.

32. A base station in a serving wireless network, the base station being configured to:
collect information regarding a neighboring wireless network of the serving wireless network; and
perform measurement of the neighboring wireless network based on the collected information.

33. The base station of claim 32, wherein the neighboring wireless network is unknown to the serving wireless network, the base station being configured to:
request a user terminal to collect the information regarding the neighboring wireless network.

34. The base station of claim 32, wherein neighboring wireless network is known to the serving wireless network, the base station being configured to:
acquire the information regarding the neighboring wireless network through a network backbone.
